(19) United States
(12) Patent Application Publication
(10) Pub. No.: US 2005/0153804 A1
(43) Pub. Date: Jul. 14, 2005

(54) Transmission squarification

(76) Inventor: Heerke Hoogenberg, Rijssen (NL)

Correspondence Address: THE WEBB LAW FIRM, P.C., 700 KOPPERS BUILDING, 436 SEVENTH AVENUE, PITTSBURGH, PA, 15219, US

(21) Appl. No.: 10/491,610

(22) PCT Filed: Oct. 2, 2002
(86) PCT No.: PCT/NL02/00631

(30) Foreign Application Priority Data
Oct. 4, 2001 (NL) 1019109

(51) Int. Cl. F16H 55/56; F16H 61/00

(52) U.S. Cl. 474/27; 474/8

(57) ABSTRACT

A mechanical transmission, comprising: an input shaft, an output shaft, a continuously variable transmission with a first transmission shaft and a second transmission shaft; a first clutch for coupling the input shaft to the first transmission shaft; a second clutch for coupling the output shaft to the second transmission shaft; a third clutch for coupling the output shaft to the first transmission shaft; and a fourth clutch for coupling the input shaft to the second transmission shaft, wherein the clutches are arranged substantially co-axially to at least one of the first and the second transmission shaft.

The invention relates to a mechanical transmission, comprising
an input shaft
an output shaft
a continuously variable transmission with a first transmission shaft and a second transmission shaft;
a first clutch for coupling the input shaft to the first transmission shaft;
a second clutch for coupling the output shaft to the second transmission shaft;
a third clutch for coupling the output shaft to the first transmission shaft; and
a fourth clutch for coupling the input shaft to the second transmission shaft, wherein the clutches are arranged substantially co-axially to at least one of the first and the second transmission shaft.

With an above stated transmission according to the invention it is possible to square the transmission ratio of the continuously variable transmission. It is thus possible to increase the range of a continuously variable transmission whose range of transmission ratio is commercially unfavourable such that the transmission does acquire a favourable range of transmission ratio.

This transmission squaring takes place through appropriate actuation of the clutches. The input shaft is thus first coupled to the first transmission shaft and the output shaft is coupled to the second transmission shaft. When the maximum transmission ratio of the continuously variable transmission is reached, the clutches are disengaged and the input shaft is coupled to a second transmission shaft and the output shaft is coupled to the first transmission shaft so that the continuously variable transmission is reversed and the transmission ratio is thus also reversed. Suppose that the continuously variable transmission has a transmission ratio of 1:2, this construction then results in a transmission ratio of ½:2, which is the same as 1:4.

Through the coaxial placing of the clutches on at least one of the first and the second transmission shaft, it is possible for the clutches to have dimensions practically as large as the continuously variable transmission, without these influencing the dimensions of the whole mechanical transmission. It is not therefore necessary to compromise between the dimensions of the whole mechanical transmission and the power which the clutches can transmit, this power being limited by the dimensions of the clutches.

The first and second transmission shafts are preferably coaxial.

In a preferred embodiment of the transmission according to the invention, the continuously variable transmission comprises at least one push belt. Continuously variable transmissions with push belts have the advantage that they have a very high efficiency and can transmit great power. The drawback however is that such transmissions have a relatively low transmission ratio. By now applying such a continuously variable transmission in a transmission according to the invention the advantages of a high efficiency and great power are retained, while a large range of transmission ratio is moreover obtained.

In another embodiment of a transmission according to the invention the continuously variable transmission comprises at least two transmission stages placed in series. By connecting two transmission stages in series the transmission ratio of the continuously variable transmission is increased, while the external dimensions of the transmission can remain limited.

In a preferred embodiment the transmission ratio of the continuously variable transmission in at least one position is 1. In this position the continuously variable transmission can then be readily switched by means of the clutches.

In a preferred embodiment this transmission ratio is a limit value of the range of transmission ratio of the continuously variable transmission.

In yet another embodiment of the transmission according to the invention, the input and output shafts are arranged parallel to each other and the outer ends thereof extend in the same direction. This means that the input and output shafts protrude on one side of the transmission and can thus be easily coupled to another part of a transmission.

These and other features of the invention are further elucidated with reference to the annexed drawings.

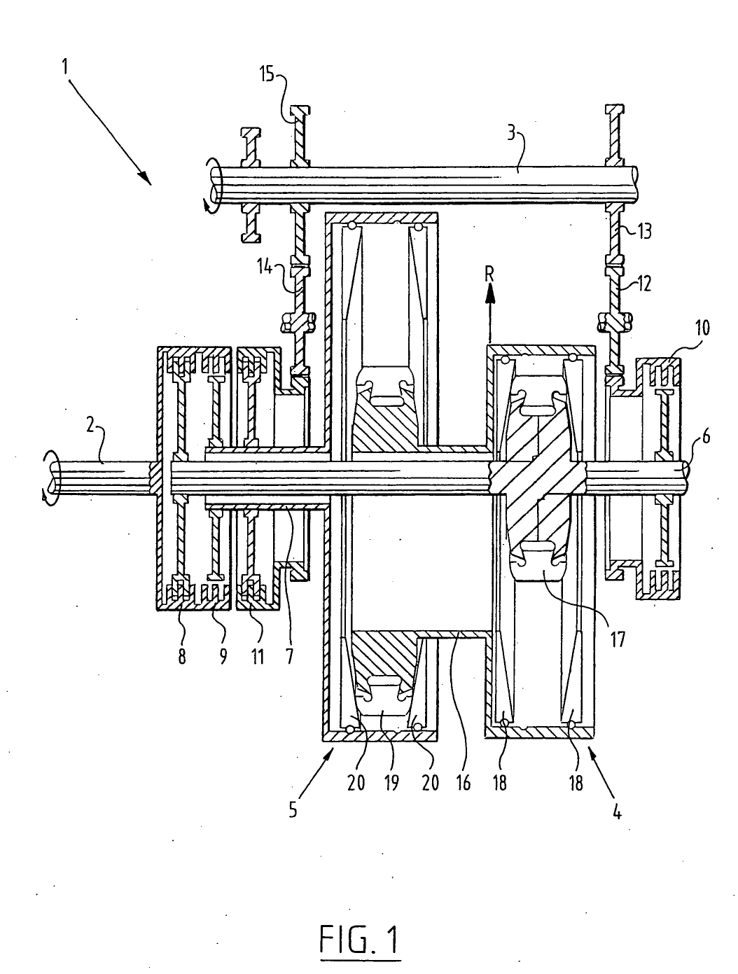

FIGS. 1-3 show schematically a first embodiment of a mechanical transmission according to the invention in three different positions.

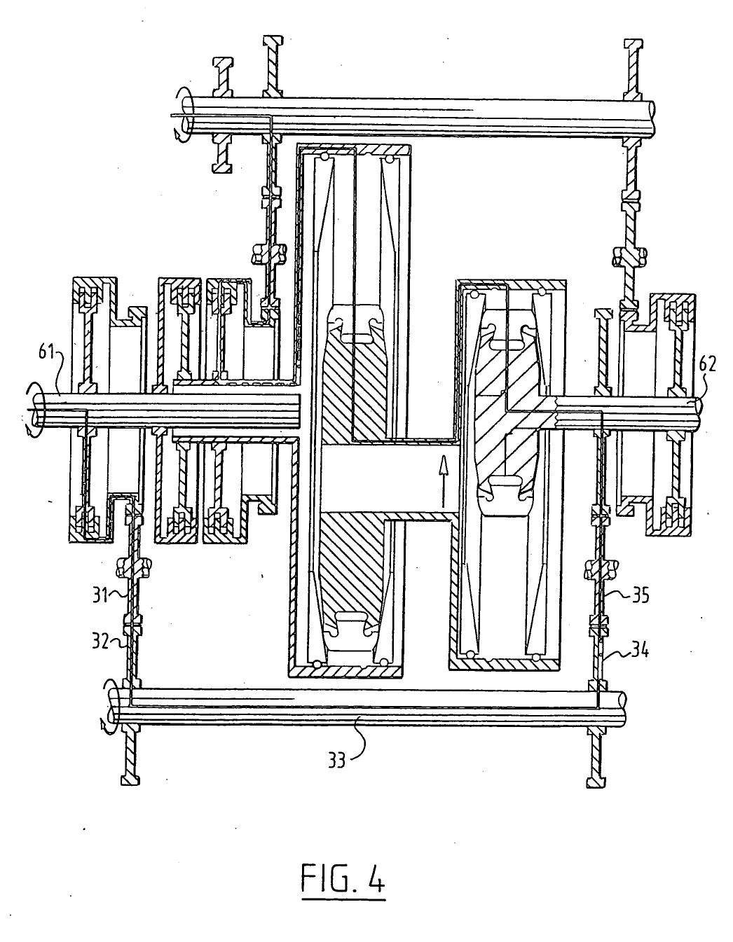

FIG. 4 shows a second embodiment of a mechanical transmission according to the invention.

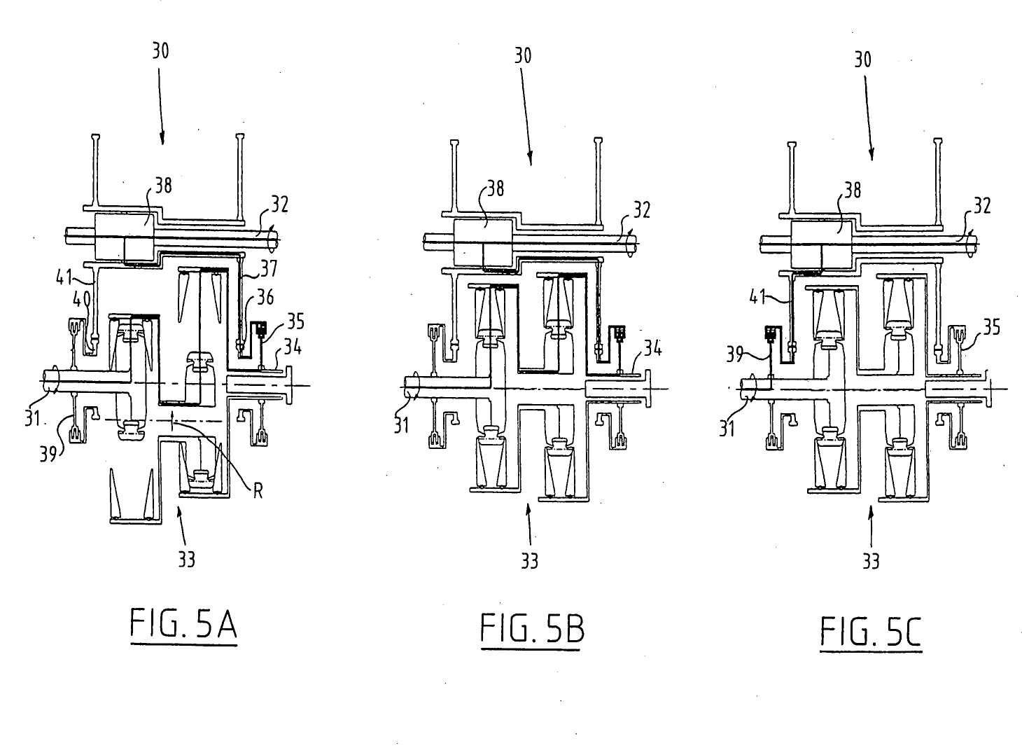

FIGS. 5A-5C show a third embodiment of a mechanical transmission in three different positions.

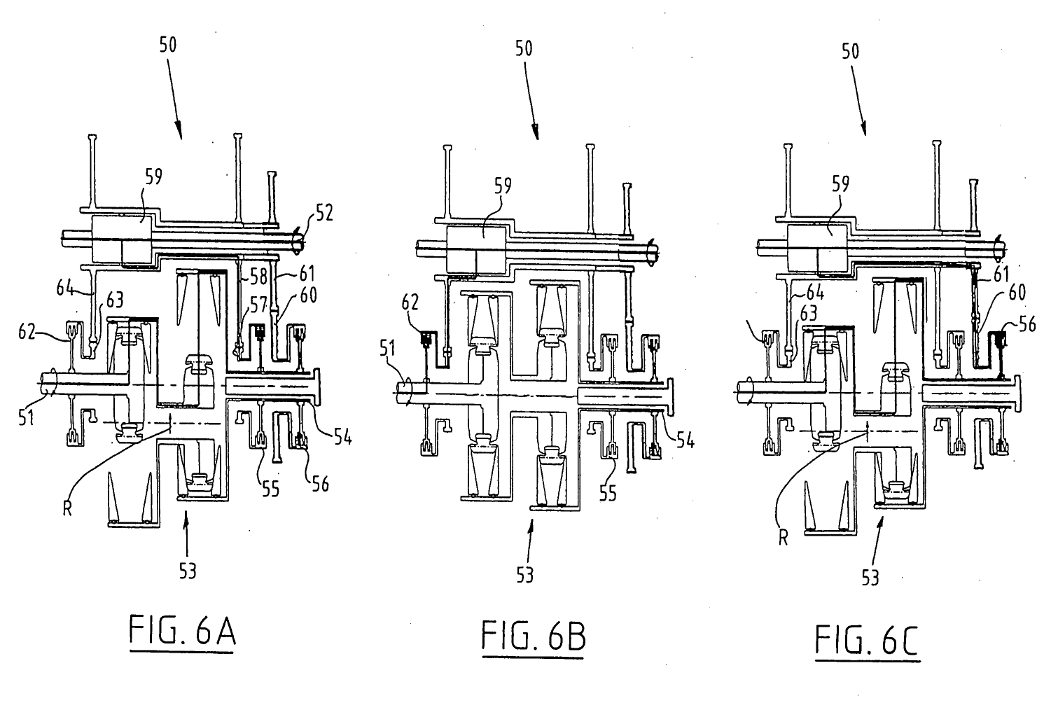

FIGS. 6A-6C show a fourth embodiment of a mechanical transmission in three different positions.

FIG. 1 shows a mechanical transmission 1 according to the invention. This mechanical transmission 1 has an input shaft 2 and an output shaft 3. The outer ends of this input shaft 2 and output shaft 3 extend in the same direction. A variable transmission consisting of two stages 4, 5 is arranged in mechanical transmission 1. This first stage 4 is connected in series to the second stage 5.

The first stage 4 is coupled to a first transmission shaft 6 and the second stage 5 is coupled to a second transmission shaft 7.

Input shaft 2 is coupled via a first multi-plate clutch 8 to the first transmission shaft 6. Input shaft 2 is further coupled via a second multi-plate clutch 9 to the second transmission shaft 7.

The first transmission shaft 6 is coupled to output shaft 3 via a third multi-plate clutch 10 and via toothed wheels 12, 13. The second transmission shaft 7 is also coupled to output shaft 3 via a fourth multi-plate clutch 11 and toothed wheels 14, 15.

It is self-evident that, instead of multi-plate clutches, clutches of another type can also be used.

In the position shown in FIG. 1, the first clutch 8 and fourth clutch 11 are in engaged state, while second clutch 9 and third clutch 10 are in disengaged state. The first stage 4 and second stage 5 of the continuously variable transmission further have the smallest transmission ratio.

Rotation of input shaft 2 is transmitted via the first clutch to the first transmission shaft 6. This then rotates the first stage 4 and second stage 5, as a result of which the second transmission shaft 7 rotates and via fourth clutch 11 transmits this rotation via toothed wheels 14 and 15 to output shaft 3.

In order to now increase the transmission ratio between input shaft 2 and output shaft 3, the connecting body 16 which connects first stage 4 to second stage 5 is displaced inward in radial direction R. Push belt 17 of the first stage 4 will hereby engage on a part of the conical discs 18 that lies further inward in radial direction, whereby connecting body 16 acquires a greater rotation speed.

Through displacement of connecting body 16 in the radial direction R the push belt 19 of the second stage 5 also engages at a position of conical discs 20 which lies further inward, whereby the second transmission shaft 7 will once again acquire a greater rotation speed.

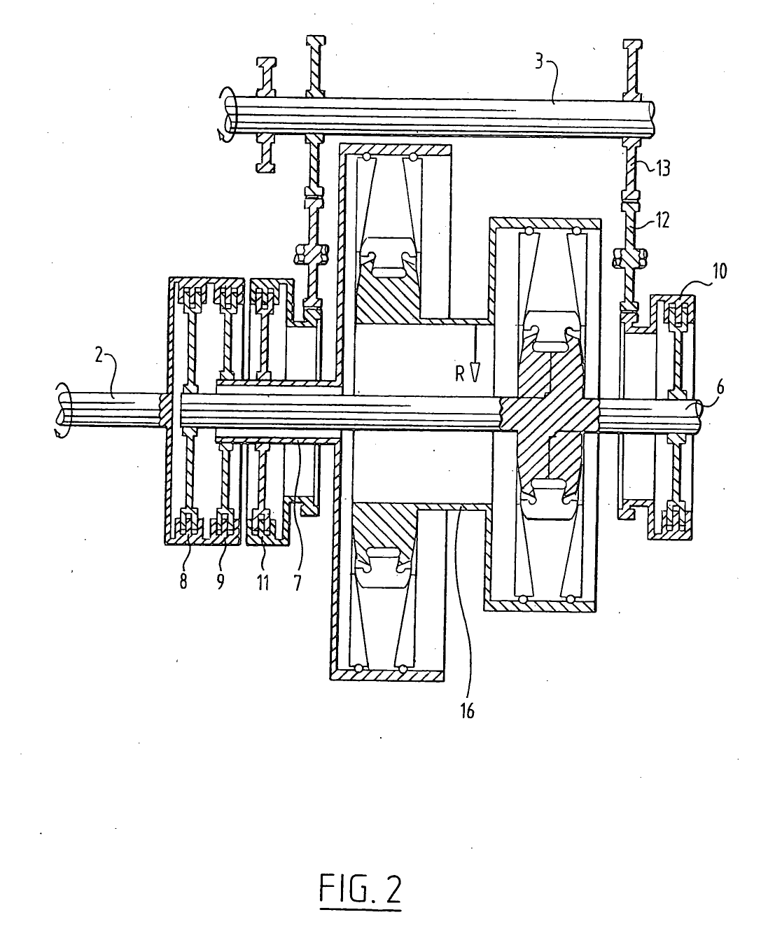

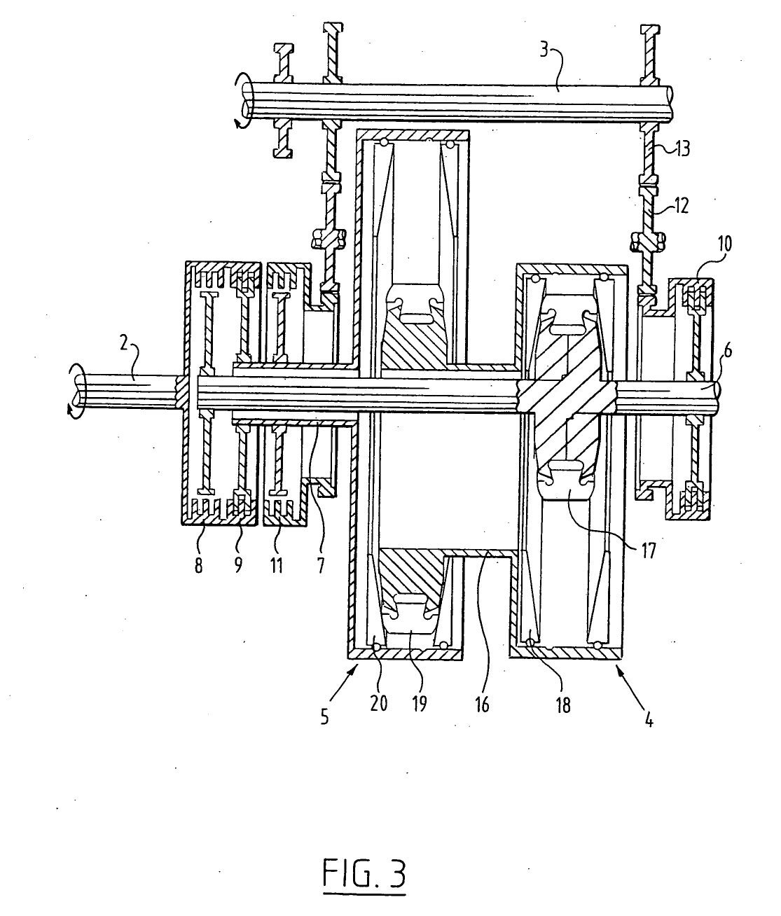

With increasing displacement of connecting body 16 in radial direction R, this body comes to lie practically coaxially with the first transmission shaft 6 and second transmission shaft 7. In this position the transmission ratio between the first transmission shaft 6 and the second transmission shaft 7 equals 1. In this position, as shown in FIG. 2, it is possible to energize all clutches 8, 9, 10, 11. The first clutch 8 and fourth clutch 11 are then disengaged, so that input shaft 2 is now connected via second clutch 9 to the second transmission shaft 7 and output shaft 3 is connected via toothed wheels 12, 13 and third clutch 10 to the first transmission shaft 6. Connecting body 16 is then displaced outward again in radial direction R to the position as shown in FIG. 3. Rotation of input shaft 2 now drives the second transmission shaft 7 via second clutch 9. The second stage 5 is driven first of all as a result. Because connecting body 16 is displaced outward in radial direction R, the conical discs 20 drive the push belt 19, whereby this latter acquires a higher rotation speed than the second transmission shaft 7. This rotation of push belt 19 is then transmitted to conical discs 18 of the first stage 4 which then drives push belt 17. Here too an acceleration takes place, whereby the first transmission shaft 6 has a higher rotation speed than the second transmission shaft 7. This rotation of the first transmission shaft 6 is then transferred via third clutch 10 and toothed wheels 12 and 13 to output shaft 3.

In the above described manner the transmission ratio of the first and second stages 4, 5 is thus used twice. Suppose that the transmission ratio between the first transmission shaft 6 and the second transmission shaft 7 can be varied between a ½ and 1, in the position shown in FIG. 1 the transmission ratio between input shaft 2 and output shaft 3 then equals 1:½. By displacing the connecting body 16 the transmission ratio of the first transmission shaft 6 and second transmission shaft 7 is then changed to 1, as shown in FIG. 2. In this position the transmission ratio between input shaft 2 and output shaft 3 equals 1. Switching then takes place and the first stage 4 and the second stage 5 are adjusted such that the transmission ratio-between the first transmission shaft 6 and the second transmission shaft 7 equals ½:1. However, since the clutches between input shaft 2, output shaft 3, first transmission shaft 6 and second transmission shaft 7 are now switched, the transmission ratio between input shaft 2 and output shaft 3 does not equal ½, but equals 2. Thus is created a range in transmission ratios of input shaft 2 and output shaft 3 equalling 1:4.

FIG. 4 shows a second embodiment of a mechanical transmission 30. The construction of this mechanical transmission 30 largely corresponds with the mechanical transmission 1. Corresponding parts are therefore designated with the same reference numerals. In mechanical transmission 1 the first transmission shaft 6 runs through the second stage 5. The stroke of the second stage 5 is hereby bounded.

FIG. 4 thus shows a second embodiment of a mechanical transmission 30 according to the invention, wherein the first transmission shaft 6 is interrupted at the position of the second stage 5 so that this latter can make a larger stroke. A larger transmission ratio can hereby be created. The clutch between the two parts of 6₁ and 6₂ of the interrupted first transmission shaft 6 is coupled via toothed wheels 31, 32, auxiliary shaft 33 and toothed wheels 34 and 35.

The position shown in FIG. 4 corresponds with the position of the mechanical transmission 1 shown in FIG. 1.

In FIGS. 5A to 5C is shown a third embodiment of a mechanical transmission. This mechanical transmission 30 has an input shaft 31 and an output shaft 32. The first shaft 31 is coupled directly to a continuously variable transmission 33, preferably consisting of two stages. Output shaft 34 of this transmission 33 is coupled to a clutch 35, which is further coupled to output shaft 32 via toothed wheels 36 and 37 and differential 38. Further arranged on the input shaft is a second clutch 39 which via toothed wheels 40 and 41 is likewise coupled to output shaft 32 via differential 38.

In FIG. 5A the continuously variable transmission 33 has its lowest transmission ratio. Clutch 35 is further engaged and clutch 39 is disengaged. Rotation of input shaft 31 causes the continuously variable transmission 33 to rotate and thus drive output shaft 32 via clutch 35, toothed wheels 36, 37 and differential 38.

The continuously variable transmission 33 is then displaced inward in radial direction R, whereby the transmission ratio of the variable transmission increases. Shown in FIG. 5B is the position in which the variable transmission 33 has a transmission ratio such that input shaft 31 and output shaft 34 of variable transmission 33 have an equal rotation speed. In this position the second clutch 39 can be engaged and the first clutch 35 can be disengaged. The variable transmission 33 is thus removed from the drive line and input shaft 31 drives output shaft 32 directly via clutch 39 and toothed wheels 40, 41 and differential 38 (see FIG. 5C). In this position the drive losses of mechanical transmission 33 are minimized.

FIGS. 6A to 6C show a fourth embodiment 50 of a mechanical transmission. This mechanical transmission 50 has an input shaft 51 and an output shaft 52. A preferably two-stage continuously variable transmission 53 is coupled directly to first shaft 51. A first clutch 55 and a second clutch 56 are arranged on output shaft 54 of this continuously variable transmission 53. The first clutch 55 is coupled to output shaft 52 via toothed wheels 57 and 58 via differential 59. Via toothed wheels 60 and 61 the second clutch is likewise coupled via differential 59 to output shaft 52. The transmission ratios between toothed wheels 57 and 58 and between toothed wheels 60 and 61 differ from each other.

Further arranged on input shaft 51 is a third clutch 62 which is coupled to output shaft 52 via toothed wheels 63 and 64 via differential 59. The transmission ratio of toothed wheels 63 and 64 is the same as the transmission ratio of toothed wheels 57 and 58. In the position shown in FIG. 6A the first clutch 55 is engaged and the second and third clutches 56 respectively 62 are disengaged. In this position the continuously variable transmission 53 is moved inward in radial direction R. The transmission ratio of the continuously variable transmission 53 hereby increases up to the position, shown in FIG. 6B, in which the rotation speed of input shaft 51 equals that of output shaft 54 of the continuously variable transmission 53. In this position the first clutch 55 is disengaged, while the third clutch 62 is engaged. The continuously variable transmission 53 is then placed back in the starting position. In this starting position the third clutch 62 is now disengaged again and the second clutch 56 is engaged. The transmission ratio of the continuously variable transmission 53 in the starting position, together with that of toothed wheels 60 and 61, is the same as the transmission ratio via clutch 62 and toothed wheels 63 and 64. The continuously variable transmission can then be displaced inward once again in radial direction R, whereby the transmission ratio of the whole mechanical transmission increases further.

In the same manner the range in transmission ratios can increase still further by adding extra stages. An additional clutch is necessary per stage on the input side, and a toothed wheel stage with clutch on the output side.

1-6. (canceled)

7. A mechanical transmission, comprising:
a) an input shaft;
b) an output shaft;
c) a continuously variable transmission with a first transmission shaft and a second transmission shaft;
d) a first clutch for coupling the input shaft to the first transmission shaft;
e) a second clutch for coupling the output shaft to the second transmission shaft;
f) a third clutch for coupling the output shaft to the first transmission shaft; and
g) a fourth clutch for coupling the input shaft to the second transmission shaft,
wherein the clutches are arranged substantially co-axially to at least one of the first and the second transmission shaft, and
wherein the first, second, third and fourth clutches are arranged coaxial.

8. The transmission as claimed in claim 7, wherein the first and second transmission shafts are coaxial.

9. The transmission as claimed in claim 7, wherein the continuously variable transmission comprises at least one push belt.

10. The transmission as claimed in claim 7, wherein the continuously variable transmission comprises at least two transmission stages placed in series.

11. The transmission as claimed in claim 7, wherein the transmission ratio of the continuously variable transmission in at least one position is 1.

12. The transmission as claimed in claim 7, wherein the input and output shafts are arranged parallel to each other and the outer ends thereof extend in the same direction.
